(19) United States
(12) Patent Application Publication
(10) Pub. No.: US 2017/0023487 A1
(43) Pub. Date: Jan. 26, 2017

(54) LIGHT COLLECTION FROM DNV SENSORS

(71) Applicant: Lockheed Martin Corporation, Bethesda, MD (US)

(72) Inventor: Brian P. Boesch, Reston, VA (US)

(73) Assignee: Lockheed Martin Corporation, Bethesda, MD (US)

(21) Appl. No.: 15/003,062

(22) Filed: Jan. 21, 2016

Related U.S. Application Data
(60) Provisional application No. 62/196,288, filed on Jul. 23, 2015.

(51) Int. Cl. G01N 21/87; G01N 21/55

(52) U.S. Cl. CPC G01N 21/87; G01N 21/55; G01N 2201/06113; G01N 2201/0637; G01N 2201/068

(57) ABSTRACT

Methods and configurations are disclosed for an efficient collection of fluorescence emitted by the nitrogen vacancies of a diamond of a DNV sensor. Some implementations may include a diamond having a nitrogen vacancy and a reflector positioned about the diamond to reflect a portion of light emitted from the diamond. In some implementations the reflector may be parabolic or ellipsoidal. In some implementations, DNV sensor may have a reflector and a concentrator. Other implementations may include a diamond with a nitrogen vacancy and a reflector positioned about the diamond to reflect a portion of light emitted from the diamond using a dielectric mirror film applied to the reflector. Still other implementations may have a diamond with a nitrogen vacancy and a dielectric mirror film coated on the diamond.

### FIELD

The subject technology generally relates to magnetometers, and more particularly, to improved light collection from diamond nitrogen-vacancy (DNV) sensors.

### BACKGROUND

Atomic-sized nitrogen-vacancy (NV) centers in diamond lattices have been shown to have excellent sensitivity for magnetic field measurement and enable fabrication of small magnetic sensors that can readily replace existing-technology (e.g., Hall-effect) systems and devices. The DNV sensors are maintained in room temperature and atmospheric pressure and can be even used in liquid environments. A green optical source (e.g., a micro-LED) can optically excite NV centers of the DNV sensor and cause emission of fluorescence radiation (e.g., red light) under off-resonant optical excitation. A magnetic field generated, for example, by a microwave coil can probe degenerate triplet spin states (e.g., with ms=−1, 0, +1) of the NV centers to split proportional to an external magnetic field projected along the NV axis, resulting in two spin resonance frequencies. The distance between the two spin resonance frequencies is a measure of the strength of the external magnetic field. A photo detector can measure the fluorescence (red light) emitted by the optically excited NV centers.

### SUMMARY

Implementations described herein relate to methods and systems for collecting fluorescence (e.g., red light) emitted by the nitrogen vacancies of a diamond of a DNV sensor. The subject technology may use reflector that can concentrate the emitted light rays from the DNV sensor onto an optical detector.

One implementation relates to a diamond nitrogen vacancy sensor that includes a diamond having a nitrogen vacancy and a reflector positioned about the diamond to reflect a portion of light emitted from the diamond.

In some implementations, the DNV sensor may further include a photo detector to measure the portion of light emitted from the diamond. In some implementations, the photo detector is sealed to a portion of the reflector. In some implementations, the reflector is parabolic or ellipsoidal. In some implementations, the diamond is positioned at a first focus of the reflector and the photo detector is positioned at a second focus of the reflector. In some implementations, the DNV sensor may further include an optical filter coupled to the photo detector. The optical filter may be a red filter. In some implementations, reflector includes an opening for an excitation laser beam to excite the diamond.

Another implementation relates to a diamond nitrogen-vacancy (DNV) sensor that includes a diamond having a nitrogen vacancy and a parabolic reflector positioned about the diamond to reflect a portion of light emitted from the diamond.

Yet another implementation relates to a diamond nitrogen-vacancy (DNV) sensor that includes a diamond having a nitrogen vacancy and an ellipsoidal reflector positioned about the diamond to reflect a portion of light emitted from the diamond.

Still another implementation relates to a diamond nitrogen-vacancy (DNV) sensor that includes a diamond having a nitrogen vacancy, a reflector positioned about the diamond to reflect a portion of light emitted from the diamond, and a concentrator coupled to the reflector and configured to concentrate the reflected portion of light.

In some implementations, the DNV sensor may further include photo detector coupled to the concentrator and configured to measure the concentrated portion of light. In some implementations, the photo detector is sealed to a portion of the concentrator. In some implementations, the reflector is parabolic or ellipsoidal. In some implementations, the diamond is positioned at a first focus of the reflector and the photo detector is positioned at a second focus of the concentrator. In some implementations, the DNV sensor may further include an optical filter coupled to the photo detector. The optical filter may be a red filter. In some implementations, reflector includes an opening for an excitation laser beam to excite the diamond. In some implementations, the opening is proximate to the photo detector.

A further implementation relates to a diamond nitrogen-vacancy (DNV) sensor that includes a diamond having a nitrogen vacancy and a reflector positioned about the diamond to reflect a portion of light emitted from the diamond. The reflector includes a dielectric mirror film.

In some implementations, the dielectric mirror film reflects only red light. In some implementations, the dielectric mirror film permits transmission of green light through the dielectric mirror film. In some implementations, the DNV sensor may further include a photo detector coupled to the reflector and configured to measure the reflected portion of light. In some implementations, the photo detector is sealed to a portion of the reflector. In some implementations, the DNV sensor may further include an optical filter coupled to the photo detector. In some implementations, the optical filter is a red filter. In some implementations, the reflector is parabolic or ellipsoidal In other implementations, the reflector can be mostly parabolic or ellipsoidal. In some implementations, the reflector includes a substrate and the dielectric mirror film is applied to the substrate. In some implementations, the substrate possesses a high clarity at a frequency of interest for the DNV sensor. In some implementations, the substrate is one of a plastic, glass, diamond, or quartz.

Still another implementations relates to a diamond nitrogen-vacancy (DNV) sensor that includes a diamond having a nitrogen vacancy and a dielectric mirror film coated on the diamond.

In some implementations, the dielectric mirror film reflects only red light. In some implementations, the dielectric mirror film permits transmission of green light through the dielectric mirror film. In some implementations, the DNV sensor may further include a photo detector coupled to the diamond and configured to measure the reflected portion of light. In some implementations, the photo detector is sealed to a portion of the diamond. In some implementations, the DNV sensor may further include an optical filter coupled to the photo detector. In some implementations, the optical filter is a red filter. In some implementations, the DNV sensor may further include a fiber conveying green light to the diamond. In some implementations, the DNV sensor may further include a microwave coil coiled about a portion of the diamond. In some implementations, the diamond is parabolic or ellipsoidal in shape.

Another implementation relates a method to for constructing a DNV sensor. The method includes providing a diamond having a nitrogen vacancy and applying a dielectric mirror film coat to a portion of the diamond.

In some implementations, the method may further include machining a portion of the diamond into a parabolic shape or an ellipsoidal shape. In some implementations, the method may further include positioning a photo detector relative to the diamond to receive light emitted from the diamond. In some implementations, a layer of the diamond does not have nitrogen vacancies.

Another implementation relates to a method to for constructing a DNV sensor. The method includes providing a diamond having a nitrogen vacancy, machining a portion of the diamond to form a reflector, and positioning a photo detector relative to the diamond to receive light emitted from the diamond.

In some implementations, the method may further include applying a dielectric mirror film coat to a portion of the diamond. In some implementations, a layer of the diamond does not have nitrogen vacancies. In some implementations, a portion of the diamond is machined into a parabolic shape or an ellipsoidal shape.

Still another implementation relates to a method to for constructing a DNV sensor. The method includes providing a diamond having a nitrogen vacancy and a reflector and positioning the diamond within the reflector such that the reflector reflects a portion of light from the diamond.

In some implementations, the method further includes positioning a photo detector relative to the diamond to receive light reflected by the reflector. In some implementations, the reflector is monolithic. In some implementations, the diamond is positioned within a borehole of the monolithic reflector. In some implementations, the borehole is backfilled. In some implementations, the reflector includes two or more pieces and positioning the diamond within the reflector includes inserting the diamond between the two or more pieces. In some implementations, the diamond is substantially flat. In some implementations, the two or more pieces of the reflector are parabolic in shape. In some implementations, the diamond is positioned parallel to or perpendicular to an axis of symmetry of the reflector. In some implementations, the two or more pieces of the reflector are ellipsoidal in shape. In some implementations, the diamond is positioned along a major axis or a minor axis of the reflector. In some implementations, positioning the diamond within the reflector includes casting the reflector about the diamond.

Still a further implementation relates to a diamond nitrogen-vacancy sensor that includes a diamond having a nitrogen vacancy, a reflector positioned about the diamond to reflect a portion of light emitted from the diamond, and a waveguide positioned within the reflector to direct light to the diamond.

In some implementations, the DNV sensor includes a photo detector to measure the portion of light emitted from the diamond. The photo detector may be sealed to a portion of the reflector. In some implementations, the DNV sensor may further include an emitter to emit light to excite the nitrogen vacancy of the diamond. The emitter can be positioned at a first end of the waveguide and the diamond can be positioned at a second end of the waveguide. In some implementations, the emitter is positioned within the photo detector, such as at a center of the photo detector. In some implementations, the photo detector and emitter are positioned on a substrate. The photo detector and emitter positioned on the substrate may form a single chip. In some implementations, the DNV sensor may further include an optical filter, such as a red filter, coupled to the photo detector. In some implementations, the reflector is parabolic. The waveguide may be positioned parallel to an axis of symmetry of the reflector. In some implementations, the reflector is ellipsoidal. The waveguide is positioned parallel to a major axis of the reflector.

In the following description, reference is made to the accompanying attachments that form a part thereof, and in which are shown by way of illustration, specific embodiments in which the subject technology may be practiced. It is to be understood that other embodiments may be utilized and changes may be made without departing from the scope of the subject technology.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview of a reflector with a diamond having nitrogen vacancies;

FIG. 2 is a side view of an ellipsoidal reflector with a diamond having nitrogen vacancies and a photo detector;

FIG. 3 is a side view of an ellipsoidal diamond having nitrogen vacancies and a photo detector;

FIG. 4 is a side view of a parabolic reflector with a diamond having nitrogen vacancies and a photo detector;

FIG. 5 is a side view of a parabolic diamond having nitrogen vacancies and a photo detector;

FIG. 6 is a side view of a parabolic reflector with a flat diamond having nitrogen vacancies inserted parallel to a major axis of the parabolic reflector and a photo detector;

FIG. 7 is a side view of a parabolic reflector with a flat diamond having nitrogen vacancies inserted parallel to a minor axis of the parabolic reflector and a photo detector;

FIG. 8 is a side view of a sensor assembly with a parabolic diamond having nitrogen vacancies and a photo detector;

FIG. 9 is a side view of a sensor assembly with a waveguide provided within a parabolic reflector;

FIG. 10 is a process diagram for a method for constructing a DNV sensor;

FIG. 11 is another process diagram for a method for constructing a DNV sensor;

FIG. 12 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of, methods, apparatuses, and systems for collecting fluorescence (e.g., red light) emitted by the nitrogen vacancies of a diamond of a DNV sensor.

In some aspects of the present technology, methods and configurations are disclosed for an efficient collection of fluorescence (e.g., red light) emitted by the nitrogen vacancies of a diamond of a DNV sensor. In some implementations, the subject technology can allow efficient collection of the emitted light of the diamond of the DNV sensor with a compact and low cost reflector. The reflector can focus the emitted light of the diamond of the DNV sensor to an optical or photo detector that can increase the amount of light detected from the diamond. In some implementations, such a configuration may detect virtually all light emitted by the diamond of the DNV sensor. In some aspects, the reflector may be shaped as a parabola, an ellipse, or other shapes that can convey the light emitted from a source to a focal point or focal area.

In some other implementations of the subject technology, the diamond of the DNV sensor may be machined or otherwise shaped to be a reflector itself. That is, the diamond with nitrogen vacancies may be shaped to form a parabolic reflector, ellipsoidal reflector or other shapes that can convey the light emitted from the nitrogen vacancies to a focal point or focal area. For example, the reflector can be mostly parabolic or ellipsoidal such that the light hits the photo detector at a 90 degree angle with some margin of error, e.g., 2 to 10 degrees.

The nitrogen vacancies of the diamond will fluoresce in response to excitation with green light and will emit red light in random directions. Because the red light measurements are shot noise limited, collecting as much emitted light as possible is desirable. In some current collection approaches using large optics, the collection efficiencies were in the range of 20%. Some implementations use a large aperture lens mounted close to the diamond or DNV sensor, which limits light collection to a fraction of the light emitted by the diamond or DNV sensor. Other implementations use a flat diamond and a number of photo detectors (e.g., four) positioned at the edges of the flat diamond. This arrangement of photo detectors may be able to capture more of the emitted light conducted to edges of the flat diamond due to internal reflection, but increases the number of photo detectors required and may not capture light emitted from the faces of the flat diamond. The DNV sensors discussed herein provide an alternative to increase the collection efficiency.

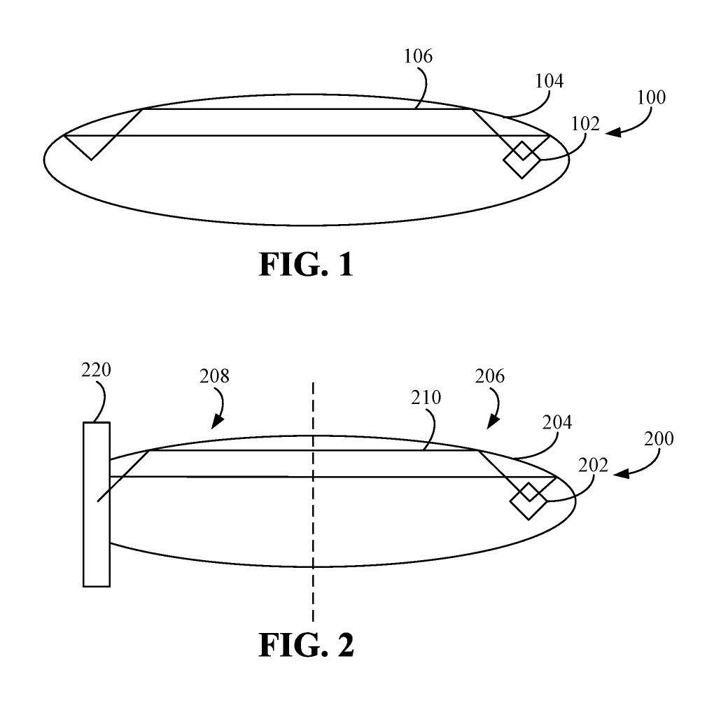

FIG. 1 depicts an overview of an assembly 100 with an example diamond 102 having nitrogen vacancies and a reflector 104 positioned about the diamond 102 for a DNV light-collection apparatus. In the implementation shown, the reflector 104 is positioned about the diamond 102 to reflect a portion of the light emitted 106 from the diamond 102. The reflector 104 is an elliptical or ellipsoidal reflector with the diamond 102 positioned within a portion of the reflector 104. In other implementations, as discussed in further detail herein, the reflector 104 may be parabolic or any other geometric configuration to reflect light emitted from the diamond 102. In some implementations, the reflector 104 may be a monolithic reflector, a hollow reflector, or any other type of reflector to reflect light emitted from the diamond 102. In the implementation shown, the diamond 102 is positioned at a focus 108 of the reflector 104. Thus, when light 106 is emitted from the diamond 102, the light is reflected by the reflector 104 toward another focus of the reflector 104. As will be discussed in further detail herein, a photo detector may be positioned at the second focus to collect the reflected light.

FIG. 2 depicts an assembly 200 with an example diamond 202 having nitrogen vacancies and an ellipsoidal reflector 204 positioned about the diamond 202 for a DNV light-collection apparatus. In some implementations, the ellipsoidal reflector 204 can be a single monolithic component that can be considered to be divided into two portions, such as a reflector portion 206 and a concentrator portion 208. In other implementations, the ellipsoidal reflector 204 may be divided into two components, such as the reflector portion 206 and the concentrator portion 208 that are coupled and/or otherwise positioned relative to each other. For instance, the reflector portion 206 and the concentrator portion 208 may be separate parabolic components that can be combined to form the ellipsoidal reflector 204. In still further configurations, the ellipsoidal reflector 204 may be composed of more than two components and can be coupled or otherwise positioned to form the ellipsoidal reflector 204.

The diamond 202 is positioned at a first focus of the ellipsoidal reflector 204 for the reflector portion 206. In some implementations, the diamond 202 is positioned at the first focus using a mount for the diamond 202. In other implementations, the diamond 202 is positioned at the first focus using a borehole through the ellipsoidal reflector 204. The borehole may be backfilled to seal the diamond 202 in the ellipsoidal reflector 204.

The ellipsoidal reflector 204 may also include an opening to allow an excitation laser beam to excite the diamond 202, such as a green excitation laser beam. The opening may be positioned at any location for the ellipsoidal reflector 204. When the diamond 202 is excited (e.g., by applying green light to the diamond 202), then the reflector portion 206 reflects the red light emitted 210 from the diamond 202 towards the concentrator portion 208.

The concentrator portion 208 directs the emitted light 210 toward a second focus of the ellipsoidal reflector 204. In the implementation shown, a photo detector 220 is positioned to receive and measure the light from the concentrator portion 208. In some implementations, the photo detector 220 is positioned at the second focus to receive the redirected emitted light. In some implementations the photo detector 220 is coupled and/or sealed to a portion of the ellipsoidal reflector 204, such as to the concentrator portion 208. In some implementations, the opening may be adjacent or proximate to the photo detector 220, such as through the concentrator portion 208. In other implementations, the opening may be opposite the photo detector 220, such as through the reflector portion 206. In still further configurations, the opening may be at any other angle and/or orientation relative to the photo detector 220.

In some implementations, an optical filter, such as a red filter, may be applied to and/or positioned on the photo detector 220 to filter out light except the relevant red light of interest. Thus, the ellipsoidal reflector 204 is concatenated with a non-focusing concentrator that can capture the emitted light from a light source (e.g., from the nitrogen vacancies of the diamond of a DNV sensor) to a single photo detector. In some instances, the loss of emitted light can be limited to the light loss due to the mount for the diamond and/or the small entrance for the green stimulation laser beam.

The foregoing solution provides high light collection efficiency to collect the light emitted from the diamond 202, while utilizing a reflector 204 that may not require high precision refinements. Such a reflector 204 may be a low cost solution to increase the light collection efficiency, such as using a reflective mirror component. In addition, the shape of the ellipsoidal reflector 204 may separate the electronics of the photo detector 220 from the diamond 202, which may decrease the magnetic interaction between the electronics of the photo detector 220 and the diamond 202.

The elliptical reflector 204 may, in some implementations, include a substrate with a dielectric mirror film or coating applied to reflect the emitted light 210. The dielectric mirror film may be selected for the specific frequency of interest. In some implementations, the thickness of the dielectric mirror material may affect the specific frequency of interest. For instance, the substrate may possess a high clarity at a frequency of interest for the DNV sensor. The substrate may be made of a plastic, glass, diamond, quartz, and/or any other suitable material. The dielectric mirror film may be applied to the substrate such that the light emitted 210 from the diamond 202 is reflected within the ellipsoidal reflector 204. In some implementations, the dielectric mirror film may only reflect red light such that other colors or wavelengths of light pass through the ellipsoidal reflector 204. For instance, such a dielectric mirror film may permit transmission of green wavelength light, such as from an excitation laser beam, through the ellipsoidal reflector 204 to the diamond 202 to excite the diamond 202.

In some aspects, such as for precision sensors, the separation between the diamond 202 and the electronics of the photo detector 220 can be extended, for example to several feet. In some implementations, the thin dielectric mirror film is used in the ellipsoidal reflector 204 to allow an RF antenna to be located inside the ellipsoidal reflector 204. In some applications, the antenna may instead be outside of the ellipsoidal reflector 204.

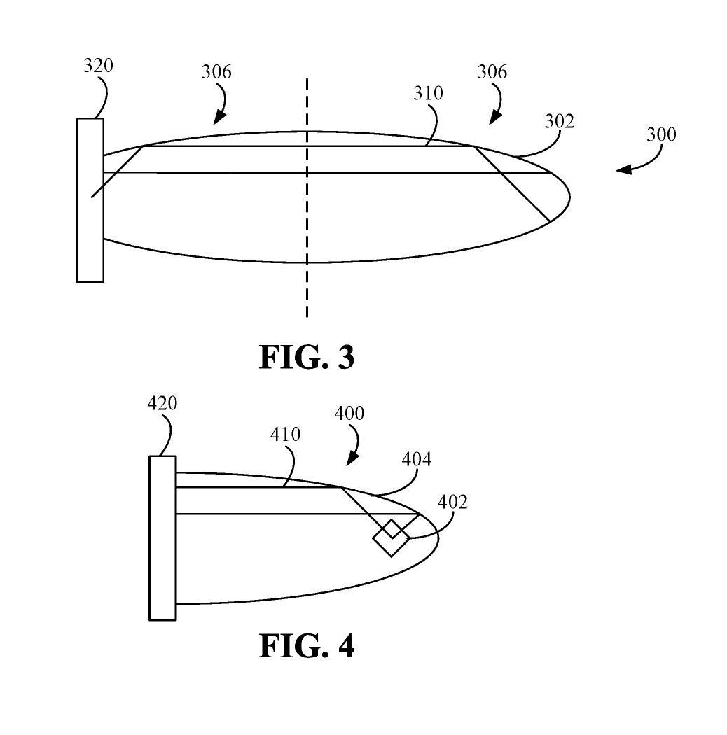

FIG. 3 depicts an assembly 300 with an example diamond 302 having nitrogen vacancies that is formed or machined into a reflector configuration for a DNV light-collection apparatus. The diamond 302 in the present configuration is formed or machined into an ellipsoidal reflector and is a monolithic component that can be considered to be divided into two portions, such as a reflector portion 304 and a concentrator portion 306.

The diamond 302 may have a dielectric mirror film coated on or applied to the diamond 302. The dielectric mirror film may be selected for the specific frequency of interest. In some implementations, the thickness of the dielectric mirror material may affect the specific frequency of interest. The dielectric mirror film may be applied such that the light emitted 310 from the nitrogen vacancies within the diamond 302 is reflected within the reflector portion 304 and concentrator portion 306 of the diamond 302. In some implementations, the dielectric mirror film may only reflect red light such that other colors or wavelengths of light pass through the diamond 302. For instance, such a dielectric mirror film may permit transmission of green wavelength light, such as from an excitation laser beam, through the dielectric mirror film to the nitrogen vacancies of the diamond 302 to excite the nitrogen vacancies of the diamond 302.

The reflector portion 304 of the diamond 302 may internally reflect the emitted light 310 via the dielectric mirror film applied to the diamond 302. Thus, the diamond 302 internally reflects the red light emitted 310 from the diamond 302 towards the concentrator portion 306. The concentrator portion 306 also redirects the light emitted 310 by the nitrogen vacancies of the diamond 302 toward a focus of the concentrator portion 306 of the diamond 302. In the implementation shown, a photo detector 320 is positioned to receive and measure the light from the concentrator portion 306. In some implementations, the photo detector 320 is positioned at the focus to receive the redirected emitted light 310. In some implementations the photo detector 320 is coupled and/or sealed to a portion of the diamond 302, such as to the concentrator portion 306.

In some implementations, an optical filter, such as a red filter, may be applied to and/or positioned on the photo detector 320 to filter out light except the relevant red light of interest.

In some implementations, a portion of the diamond 302 may be formed without nitrogen vacancies. That is, for instance, one or more layers for the diamond may be formed by chemical deposition without nitrogen vacancies. The one or more layers may be machined or formed for the concentrator portion such that the emitted light reflected by the reflector portion 304 is not reabsorbed by nitrogen vacancies when travelling through the concentrator portion 306 of the diamond 302.

FIG. 4 depicts an assembly 400 with an example diamond 402 having nitrogen vacancies and a parabolic reflector 404 positioned about the diamond 402 for a DNV light-collection apparatus. In some implementations, the parabolic reflector 404 can be a single monolithic component. In some configurations, the parabolic reflector 404 may be composed of more than two components and can be coupled or otherwise positioned to form the parabolic reflector 404.

The diamond 402 is positioned at a focus of the parabolic reflector 404. In some implementations, the diamond 402 is positioned at the focus using a mount for the diamond 402. In other implementations, the diamond 402 is positioned at the focus using a borehole through the parabolic reflector 404. The borehole may be backfilled to seal the diamond 402 in the parabolic reflector 404.

The parabolic reflector 404 may also include an opening to allow an excitation laser beam to excite the diamond 402, such as a green excitation laser beam. The opening may be positioned at any location for the parabolic reflector 404. When the diamond 402 is excited (e.g., by applying green light to the diamond 402), then the parabolic reflector 404 reflects the red light emitted 410 from the diamond 402 towards a photo detector 420. In the implementation shown, a photo detector 420 is positioned to receive and measure the light from the parabolic reflector 404. In some implementations the photo detector 420 is coupled and/or sealed to a portion of the parabolic reflector 404. In some implementations, the opening may be adjacent or proximate to the photo detector 420. In other implementations, the opening may be opposite the photo detector 420. In still further configurations, the opening may be at any other angle and/or orientation relative to the photo detector 420.

In some implementations, an optical filter, such as a red filter, may be applied to and/or positioned on the photo detector 420 to filter out light except the relevant red light of interest. Thus, the parabolic reflector 404 is concatenated with a non-focusing concentrator that can capture the emitted light from a light source (e.g., from the nitrogen vacancies of the diamond of a DNV sensor) to a single photo detector. In some instances, the loss of emitted light can be limited to the light loss due to the mount for the diamond and/or the small entrance for the green stimulation laser beam.

The foregoing solution provides high light collection efficiency to collect the light emitted from the diamond 402, while utilizing a parabolic reflector 404 that may not require high precision refinements. Such a parabolic reflector 404 may be a low cost solution to increase the light collection efficiency, such as using a reflective mirror component. In addition, the shape of the parabolic reflector 404 may separate the electronics of the photo detector 420 from the diamond 402, which may decrease the magnetic interaction between the electronics of the photo detector 420 and the diamond 402.

The parabolic reflector 404 may, in some implementations, include a substrate with a dielectric mirror film or coating applied to reflect the emitted light 410. The dielectric mirror film may be selected for the specific frequency of interest. In some implementations, the thickness of the dielectric mirror material may affect the specific frequency of interest. For instance, the substrate may possess a high clarity at a frequency of interest for the DNV sensor. The substrate may be made of a plastic, glass, diamond, quartz, and/or any other suitable material. The dielectric mirror film may be applied to the substrate such that the light emitted 410 from the diamond 402 is reflected within the parabolic reflector 404. In some implementations, the dielectric mirror film may only reflect red light such that other colors or wavelengths of light pass through the parabolic reflector 404. For instance, such a dielectric mirror film may permit transmission of green wavelength light, such as from an excitation laser beam, through the parabolic reflector 404 to the diamond 402 to excite the diamond 402.

In some aspects, such as for precision sensors, the separation between the diamond 402 and the electronics of the photo detector 420 can be extended, for example to several feet. In some implementations, the thin dielectric mirror film is used in the parabolic reflector 404 to allow an RF antenna to be located inside the parabolic reflector 404. In some applications, the antenna may instead be outside of the parabolic reflector 404.

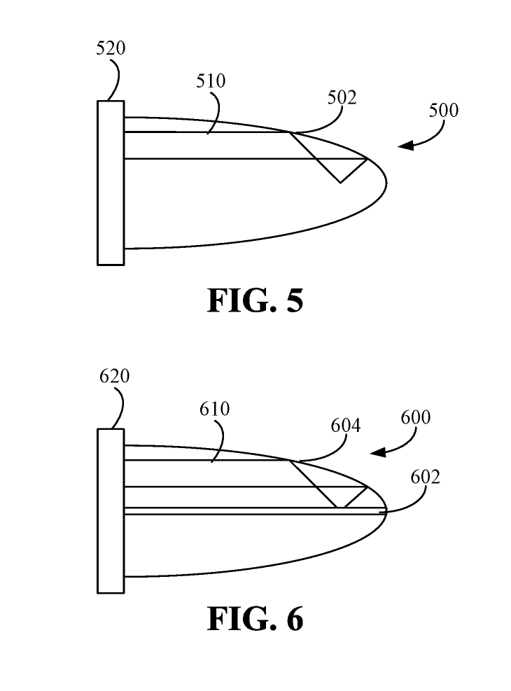

FIG. 5 depicts an assembly 500 with an example diamond 502 having nitrogen vacancies that is formed or machined into a reflector configuration for a DNV light-collection apparatus. The diamond 502 in the present configuration is formed or machined into a parabolic reflector and is a monolithic component.

The diamond 502 may have a dielectric mirror film coated on or applied to the diamond 502. The dielectric mirror film may be selected for the specific frequency of interest. In some implementations, the thickness of the dielectric mirror material may affect the specific frequency of interest. The dielectric mirror film may be applied such that the light emitted 510 from the nitrogen vacancies within the diamond 502 is reflected within the diamond 502. In some implementations, the dielectric mirror film may only reflect red light such that other colors or wavelengths of light pass through the diamond 502. For instance, such a dielectric mirror film may permit transmission of green wavelength light, such as from an excitation laser beam, through the dielectric mirror film to the nitrogen vacancies of the diamond 502 to excite the nitrogen vacancies of the diamond 502.

The parabolic reflector configuration for the diamond 502 may internally reflect the emitted light 510 via the dielectric mirror film applied to the diamond 502. Thus, the diamond 502 internally reflects the red light emitted 510 from the diamond 502 a photo detector 520 that is positioned to receive and measure the light emitted. In some implementations the photo detector 520 is coupled and/or sealed to a portion of the diamond 502.

In some implementations, an optical filter, such as a red filter, may be applied to and/or positioned on the photo detector 520 to filter out light except the relevant red light of interest.

In some implementations, a portion of the diamond 502 may be formed without nitrogen vacancies. That is, for instance, one or more layers for the diamond may be formed by chemical deposition without nitrogen vacancies. The one or more layers may be machined or formed near the junction for the photo detector 520 such that the emitted light reflected by the parabolic reflector configuration of the diamond 502 is not reabsorbed by nitrogen vacancies when travelling through the one or more layers of the diamond 502.

FIG. 6 depicts another implementation of a parabolic reflector configuration for an assembly 600 for a DNV sensor. An example thin diamond 602 having nitrogen vacancies may be inserted into a portion of a parabolic reflector 604 positioned about the diamond 602 for a DNV light-collection apparatus. In some implementations, the parabolic reflector 604 can be a single monolithic component that is split into two portions to insert the thin diamond 602. In some other configurations, the parabolic reflector 604 may be composed of more than two components and can be coupled or otherwise positioned to form the parabolic reflector 604. In the implementation shown, the thin diamond 602 is inserted parallel to (and in some instances along) an axis of symmetry the parabolic reflector 604. In implementations utilizing an ellipsoidal reflector, the thin diamond 602 may be inserted parallel to and/or along a major axis of the ellipsoidal reflector.

The parabolic reflector 604 may also include an opening to allow an excitation laser beam to excite the diamond 602, such as a green excitation laser beam. The opening may be positioned at any location for the parabolic reflector 604. When the diamond 602 is excited (e.g., by applying green light to the diamond 602), then the parabolic reflector 604 reflects the red light emitted 610 from the diamond 602 towards a photo detector 620. In the implementation shown, a photo detector 620 is positioned to receive and measure the light from the parabolic reflector 604. In some implementations the photo detector 620 is coupled and/or sealed to a portion of the parabolic reflector 604. In some implementations, the opening may be adjacent or proximate to the photo detector 620. In other implementations, the opening may be opposite the photo detector 620. In still further configurations, the opening may be at any other angle and/or orientation relative to the photo detector 620.

In some implementations, an optical filter, such as a red filter, may be applied to and/or positioned on the photo detector 620 to filter out light except the relevant red light of interest. Thus, the parabolic reflector 604 is concatenated with a non-focusing concentrator that can capture the emitted light from a light source (e.g., from the nitrogen vacancies of the diamond of a DNV sensor) to a single photo detector. In some instances, the loss of emitted light can be limited to the light loss due to the mount for the diamond and/or the small entrance for the green stimulation laser beam.

The foregoing solution provides high light collection efficiency to collect the light emitted from the diamond 602, while utilizing a parabolic reflector 604 that may not require high precision refinements. Such a parabolic reflector 604 may be a low cost solution to increase the light collection efficiency, such as using a reflective mirror component. In addition, the shape of the parabolic reflector 604 may separate the electronics of the photo detector 620 from the diamond 602, which may decrease the magnetic interaction between the electronics of the photo detector 620 and the diamond 602.

The parabolic reflector 604 may, in some implementations, include a substrate with a dielectric mirror film or coating applied to reflect the emitted light 610. The dielectric mirror film may be selected for the specific frequency of interest. In some implementations, the thickness of the dielectric mirror material may affect the specific frequency of interest. For instance, the substrate may possess a high clarity at a frequency of interest for the DNV sensor. The substrate may be made of a plastic, glass, diamond, quartz, and/or any other suitable material. The dielectric mirror film may be applied to the substrate such that the light emitted 610 from the diamond 602 is reflected within the parabolic reflector 604. In some implementations, the dielectric mirror film may only reflect red light such that other colors or wavelengths of light pass through the parabolic reflector 604. For instance, such a dielectric mirror film may permit transmission of green wavelength light, such as from an excitation laser beam, through the parabolic reflector 604 to the diamond 602 to excite the diamond 602.

In some aspects, such as for precision sensors, the separation between the diamond 602 and the electronics of the photo detector 620 can be extended, for example to several feet. In some implementations, the thin dielectric mirror film is used in the parabolic reflector 604 to allow an RF antenna to be located inside the parabolic reflector 604. In some applications, the antenna may instead be outside of the parabolic reflector 604.

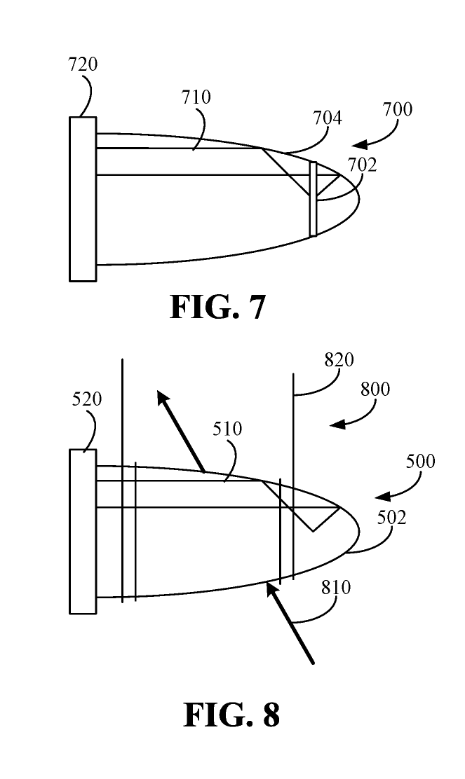

FIG. 7 depicts another implementation of a parabolic reflector configuration for an assembly 700 for a DNV sensor. An example thin diamond 702 having nitrogen vacancies may be inserted into a portion of a parabolic reflector 704 positioned about the diamond 702 for a DNV light-collection apparatus. In some implementations, the parabolic reflector 704 can be a single monolithic component that is split into two portions to insert the thin diamond 702. In some other configurations, the parabolic reflector 704 may be composed of more than two components and can be coupled or otherwise positioned to form the parabolic reflector 704. In the implementation shown, the thin diamond 702 is inserted perpendicular to an axis of symmetry the parabolic reflector 704. In implementations utilizing an ellipsoidal reflector, the thin diamond 702 may be inserted parallel to and/or along a minor axis of the ellipsoidal reflector. In some implementations, the thin diamond 702 is positioned at a focus of the parabolic reflector 704.

The parabolic reflector 704 may also include an opening to allow an excitation laser beam to excite the diamond 702, such as a green excitation laser beam. The opening may be positioned at any location for the parabolic reflector 704. When the diamond 702 is excited (e.g., by applying green light to the diamond 702), then the parabolic reflector 704 reflects the red light emitted 710 from the diamond 702 towards a photo detector 720. In the implementation shown, a photo detector 720 is positioned to receive and measure the light from the parabolic reflector 704. In some implementations the photo detector 720 is coupled and/or sealed to a portion of the parabolic reflector 704. In some implementations, the opening may be adjacent or proximate to the photo detector 720. In other implementations, the opening may be opposite the photo detector 720. In still further configurations, the opening may be at any other angle and/or orientation relative to the photo detector 720.

In some implementations, an optical filter, such as a red filter, may be applied to and/or positioned on the photo detector 720 to filter out light except the relevant red light of interest. Thus, the parabolic reflector 704 is concatenated with a non-focusing concentrator that can capture the emitted light from a light source (e.g., from the nitrogen vacancies of the diamond of a DNV sensor) to a single photo detector. In some instances, the loss of emitted light can be limited to the light loss due to the mount for the diamond and/or the small entrance for the green stimulation laser beam.

The foregoing solution provides high light collection efficiency to collect the light emitted from the diamond 702, while utilizing a parabolic reflector 704 that may not require high precision refinements. Such a parabolic reflector 704 may be a low cost solution to increase the light collection efficiency, such as using a reflective mirror component. In addition, the shape of the parabolic reflector 704 may separate the electronics of the photo detector 720 from the diamond 702, which may decrease the magnetic interaction between the electronics of the photo detector 720 and the diamond 702.

The parabolic reflector 704 may, in some implementations, include a substrate with a dielectric mirror film or coating applied to reflect the emitted light 710. The dielectric mirror film may be selected for the specific frequency of interest. In some implementations, the thickness of the dielectric mirror material may affect the specific frequency of interest. For instance, the substrate may possess a high clarity at a frequency of interest for the DNV sensor. The substrate may be made of a plastic, glass, diamond, quartz, and/or any other suitable material. The dielectric mirror film may be applied to the substrate such that the light emitted 710 from the diamond 702 is reflected within the parabolic reflector 704. In some implementations, the dielectric mirror film may only reflect red light such that other colors or wavelengths of light pass through the parabolic reflector 704. For instance, such a dielectric mirror film may permit transmission of green wavelength light, such as from an excitation laser beam, through the parabolic reflector 704 to the diamond 702 to excite the diamond 702.

In some aspects, such as for precision sensors, the separation between the diamond 702 and the electronics of the photo detector 720 can be extended, for example to several feet. In some implementations, the thin dielectric mirror film is used in the parabolic reflector 704 to allow an RF antenna to be located inside the parabolic reflector 704. In some applications, the antenna may instead be outside of the parabolic reflector 704.

FIG. 8 depicts an assembly 800 for a DNV sensor that incorporates the assembly 500 of FIG. 5 where the diamond 502 is formed or machined into a parabolic configuration. The assembly 800 includes the photo detector 520 coupled to and/or positioned to receive the emitted light 510 from the diamond 502. The diamond 502 includes the dielectric mirror film applied to the diamond 502 to reflect the emitted red light 510 within the diamond 502. In some implementations, the dielectric mirror film may only reflect red light such that other colors or wavelengths of light pass through the diamond 502. For instance, such a dielectric mirror film may permit transmission of green wavelength light 810, such as from an excitation laser beam, through the dielectric mirror film to the nitrogen vacancies of the diamond 502 to excite the nitrogen vacancies of the diamond 502. The assembly 800 includes microwave coils about the diamond 502 such that, if the diamond 502 is irradiated with microwaves at a certain frequency, then the diamond will cease and/or reduce the emission of red light. A microwave off is performed for the DNV sensor prior to illumination of the diamond 502 to emit the red light 510. When the microwave frequency is moved to a different frequency, then the red light emitted is dimmed and the frequency is related to the strength of the magnetic field the DNV sensor is within.

In some implementations, the green light 810 from the green laser may be applied through a fiber, rather than the free air, to the diamond 502. In some implementations, the entire apparatus of FIG. 8 may be as compact as ˜2 mm. The assembly of the subject technology may be used in a number of applications, for example, in all areas of magnetometry, where DNV magnetometers are employed.

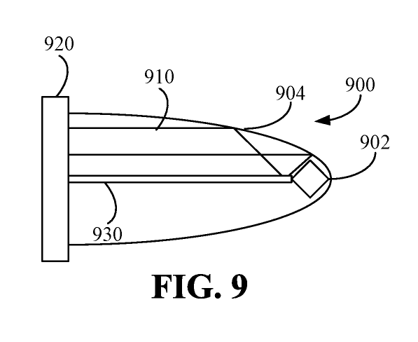

FIG. 9 depicts another implementation of a reflector configuration for an assembly 900 for a DNV sensor that includes a waveguide 930 positioned within the reflector to direct light to a diamond 902 having nitrogen vacancies. An example diamond 902 having nitrogen vacancies may be inserted into a portion of a reflector 904 positioned about the diamond 902 for a DNV light-collection apparatus. In some implementations, the reflector 904 may be a parabolic reflector or an ellipsoidal reflector. The reflector 904 can be a single monolithic component or can be a shell component with a fill, such as plastic or fiber optic material, or without a fill (e.g., empty). In the implementation shown, a waveguide 930 is formed or inserted along an axis of symmetry of the parabolic reflector 904. In other implementations, the waveguide 930 is formed or inserted along a major axis of an ellipsoidal reflector 904. The waveguide 930 may be a fiber optic component and/or may simply be a material having a differing refractive index than the reflector 904 and/or the fill within the reflector 904.

The diamond 902 is positioned at an end of the waveguide 930 such that an excitation beam, such as green laser light, can be transmitted via the waveguide 930 to the diamond 902. When the diamond 902 is excited (e.g., by applying green light to the diamond 902), then the reflector 904 reflects the red light emitted 910 from the diamond 902 towards a photo detector 920. In the implementation shown, a photo detector 920 is positioned to receive and measure the light from the reflector 904. In some implementations the photo detector 920 is coupled and/or sealed to a portion of the reflector 904. In some implementations, an opening for transmitting the excitation beam is through the photo detector 920 such that the excitation beam can be transmitted via the waveguide 930 to the diamond 902. In other implementations, an emitter to emit light to excite the nitrogen vacancy of the diamond 902, such as the excitation beam, may be provided at a first end of the waveguide 930 with the diamond 902 at a second end of the waveguide 930. In some implementations, the emitter may be formed and/or positioned within or at a center of the photo detector 920 to generate and transmit the excitation beam along the waveguide 930 to the diamond 902. The photo detector 920 and emitter may be positioned on a single substrate. Thus, a single chip can include both the photo detector 920 and the emitter for the excitation beam such that both the illumination and collection can be provided on the single chip.

In some implementations, an optical filter, such as a red filter, may be applied to and/or positioned on the photo detector 920 to filter out light except the relevant red light of interest. Thus, the reflector 904 is concatenated with a non-focusing concentrator that can capture the emitted light from a light source (e.g., from the nitrogen vacancies of the diamond of a DNV sensor) to a single photo detector. In some instances, the loss of emitted light can be limited to the light loss due to the mount for the diamond and/or any emitted light that travels back down the waveguide 930.

The foregoing solution provides high light collection efficiency to collect the light emitted from the diamond 902, while utilizing a reflector 904 that may not require high precision refinements. Such a reflector 904 may be a low cost solution to increase the light collection efficiency, such as using a reflective mirror component. In addition, the shape of the parabolic reflector 904 may separate the electronics of the photo detector 920 and/or emitter from the diamond 902, which may decrease the magnetic interaction between the electronics of the photo detector 920 and/or emitter and the diamond 902.

The reflector 904 may, in some implementations, include a substrate with a dielectric mirror film or coating applied to reflect the emitted light 910. The dielectric mirror film may be selected for the specific frequency of interest. In some implementations, the thickness of the dielectric mirror material may affect the specific frequency of interest. For instance, the substrate may possess a high clarity at a frequency of interest for the DNV sensor. The substrate may be made of a plastic, glass, diamond, quartz, and/or any other suitable material. The dielectric mirror film may be applied to the substrate such that the light emitted 910 from the diamond 902 is reflected within the reflector 904. In some implementations, the dielectric mirror film may only reflect red light such that other colors or wavelengths of light pass through the reflector 904.

In some aspects, such as for precision sensors, the separation between the diamond 902 and the electronics of the photo detector 920 can be extended, for example to several feet. In some implementations, the thin dielectric mirror film is used in the reflector 904 to allow an RF antenna to be located inside the reflector 904. In some applications, the antenna may instead be outside of the reflector 904.

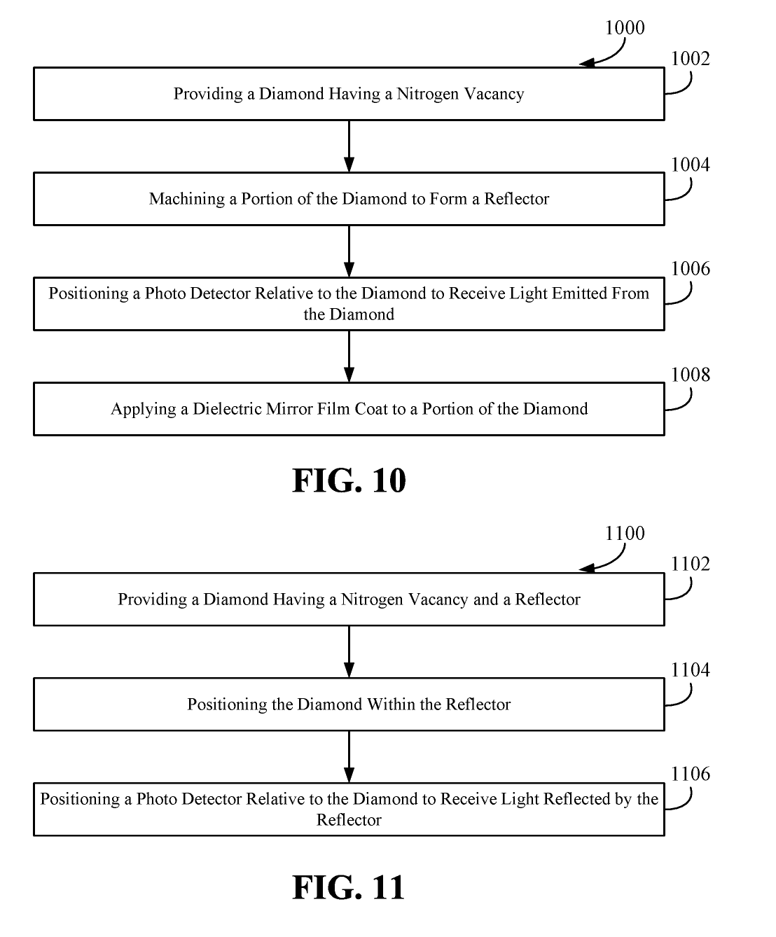

FIG. 10 depicts an implementation of a process 1000 to form a DNV sensor. The process 1000 includes providing a diamond having a nitrogen vacancy (block 1002), machining a portion of the diamond to form a reflector (block 1004), positioning a photo detector relative to the diamond to receive light emitted from the diamond (block 1006), and/or applying a dielectric mirror film coat to a portion of the diamond (block 1008). In some implementations, the process 1000 may include simple providing a diamond having a nitrogen vacancy (block 1002) and applying a dielectric mirror film coat to a portion of the diamond (block 1008).

In some implementations, the machining of the diamond to form a reflector (block 1004) may machine a portion of the diamond to form a parabolic shape, an ellipsoidal shape, and/or any other suitable shape. In some implementations, a layer of the diamond may not have nitrogen vacancies.

FIG. 11 depicts another process 1100 to form a DNV sensor. The process 1100 includes providing a diamond having a nitrogen vacancy and a reflector (block 1102), positioning the diamond within the reflector such that the reflector reflects a portion of the light from the diamond (block 1104), and/or positioning a photo detector relative to the diamond to receive light emitted from the diamond (block 1106).

In some implementations, the reflector is monolithic and the diamond is positioned within a borehole of the monolithic reflector. In some implementations, the borehole may be backfilled. In some implementations, the reflector may be formed from two or more pieces and positioning the diamond within the reflector includes inserting the diamond between the two or more pieces. In some instances, the diamond may be substantially flat, such as in the configuration shown in FIGS. 6-7. The two or more pieces of the reflector may be parabolic in shape. The diamond may be positioned parallel to an axis of symmetry of the parabolic reflector or may be positioned perpendicular to the axis of symmetry. In other implementations, the two or more pieces of the reflector may be ellipsoidal in shape. The diamond may be positioned parallel to a major axis of the ellipsoidal reflector or may be positioned parallel to a minor axis of the ellipsoidal reflector. In some further implementations, positioning the diamond within the reflector may include casting the reflector about the diamond.

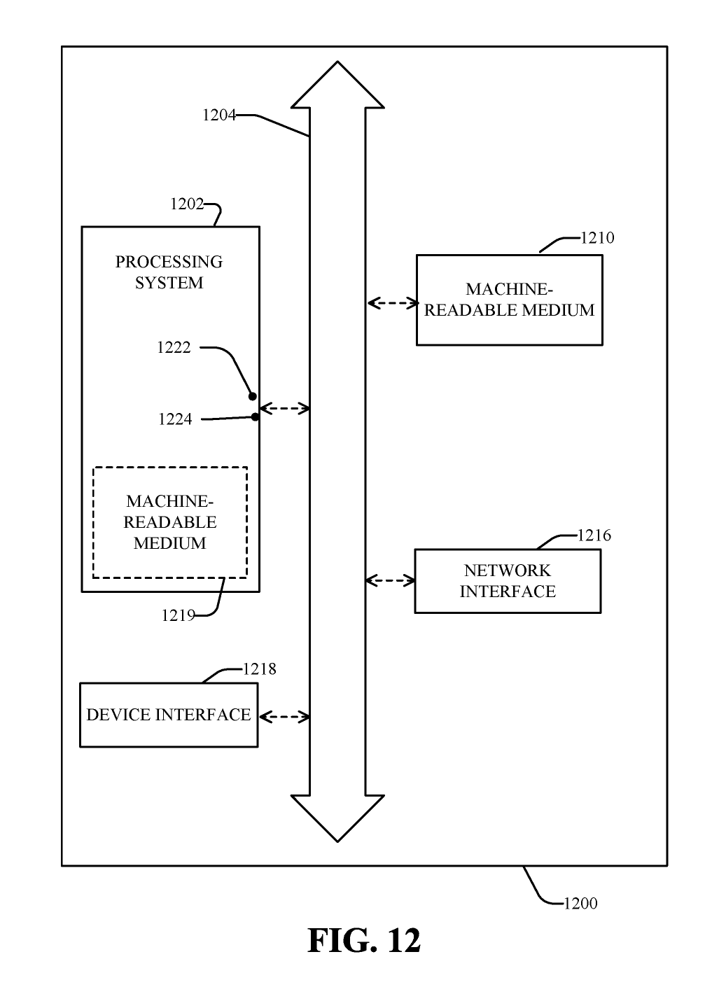

FIG. 12 is a diagram illustrating an example of a system 1200 for implementing some aspects of the subject technology. In some implementations, the system 1200 may be a processing system for processing the data output from a photo detector of the implementations describe in reference to FIGS. 2-8. The system 1200 includes a processing system 1202, which may include one or more processors or one or more processing systems. A processor can be one or more processors. The processing system 1202 may include a general-purpose processor or a specific-purpose processor for executing instructions and may further include a machine-readable medium 1219, such as a volatile or non-volatile memory, for storing data and/or instructions for software programs. The instructions, which may be stored in a machine-readable medium 1210 and/or 1219, may be executed by the processing system 1202 to control and manage access to the various networks, as well as provide other communication and processing functions. The instructions may also include instructions executed by the processing system 1202 for various user interface devices, such as a display 1212 and a keypad 1214. The processing system 1202 may include an input port 1222 and an output port 1224. Each of the input port 1222 and the output port 1224 may include one or more ports. The input port 1222 and the output port 1224 may be the same port (e.g., a bi-directional port) or may be different ports.

The processing system 1202 may be implemented using software, hardware, or a combination of both. By way of example, the processing system 1202 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable device that can perform calculations or other manipulations of information.

A machine-readable medium can be one or more machine-readable media. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media (e.g., 1219) may include storage integrated into a processing system such as might be the case with an ASIC. Machine-readable media (e.g., 1210) may also include storage external to a processing system, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. Those skilled in the art will recognize how best to implement the described functionality for the processing system 1202. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. Instructions may be executable, for example, by the processing system 1202 or one or more processors. Instructions can be, for example, a computer program including code for performing methods of the subject technology.

A network interface 1216 may be any type of interface to a network (e.g., an Internet network interface), and may reside between any of the components shown in FIG. 12 and coupled to the processor via the bus 1204.

A device interface 1218 may be any type of interface to a device and may reside between any of the components shown in FIG. 12. A device interface 1218 may, for example, be an interface to an external device (e.g., USB device) that plugs into a port (e.g., USB port) of the system 1200. In some implementations, the device interface 1218 may be an interface to the apparatus of FIGS. 1-9, where some or all of the analysis of the detected red light by the photo detector electronics is handled by the processing system 1202.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

One or more of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

In one or more implementations, the subject technology is directed to method and systems for an efficient collection of fluorescence (e.g., red light) emitted by the NV centers of a DNV sensor. In some aspects, the subject technology may be used in various markets, including for example and without limitation, advanced sensors and materials and structures.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments may be readily apparent to those skilled in the art, and generic principles defined herein may be applied to other embodiments. Thus, many changes and modifications may be made to the subject technology, by one having ordinary skill in the art, without departing from the scope of the subject technology.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases

A reference to an element in the singular is not intended to mean “one and only one” unless specifically stated, but rather “one or more.” The term “some” refers to one or more. Headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” or “processing circuit” encompass all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A diamond nitrogen-vacancy (DNV) sensor comprising:
a diamond having a nitrogen vacancy; and
a reflector positioned about the diamond to reflect a portion of light emitted from the diamond.

2. The DNV sensor of claim 1 further comprising:
a photo detector to measure the portion of light emitted from the diamond.

3. The DNV sensor of claim 2, wherein the photo detector is sealed to a portion of the reflector.

4. The DNV sensor of claim 2, wherein the reflector is parabolic.

5. The DNV sensor of claim 2, wherein the reflector is ellipsoidal.

6. The DNV sensor of claim 5, wherein the diamond is positioned at a first focus of the reflector and the photo detector is positioned at a second focus of the reflector.

7. The DNV sensor of claim 2 further comprising:
an optical filter coupled to the photo detector.

8. The DNV sensor of claim 7, wherein the optical filter is a red filter.

9. The DNV sensor of claim 1, wherein the reflector comprises an opening for an excitation laser beam to excite the diamond.

10. A diamond nitrogen-vacancy (DNV) sensor comprising:
a diamond having a nitrogen vacancy; and
a parabolic reflector positioned about the diamond to reflect a portion of light emitted from the diamond.

11. A diamond nitrogen-vacancy (DNV) sensor comprising:
a diamond having a nitrogen vacancy; and
a ellipsoidal reflector positioned about the diamond to reflect a portion of light emitted from the diamond.

12. A diamond nitrogen-vacancy (DNV) sensor comprising:
a diamond having a nitrogen vacancy;
a reflector positioned about the diamond to reflect a portion of light emitted from the diamond; and
a concentrator coupled to the reflector and configured to concentrate the reflected portion of light.

13. The DNV sensor of claim 12 further comprising:
a photo detector coupled to the concentrator and configured to measure the concentrated portion of light.

14. The DNV sensor of claim 13, wherein the photo detector is sealed to a portion of the concentrator.

15. The DNV sensor of claim 13, wherein the reflector is parabolic.

16. The DNV sensor of claim 13, wherein the reflector is ellipsoidal.

17. The DNV sensor of claim 13, wherein the diamond is positioned at a first focus of the reflector and the photo detector is positioned at a second focus of the concentrator.

18. The DNV sensor of claim 13 further comprising:
an optical filter coupled to the photo detector.

19. The DNV sensor of claim 18, wherein the optical filter is a red filter.

20. The DNV sensor of claim 12, wherein the concentrator comprises an opening for an excitation laser beam to excite the diamond.

21. The DNV sensor of claim 20, wherein the opening is proximate to the photo detector.

22. A diamond nitrogen-vacancy (DNV) sensor comprising:
a diamond having a nitrogen vacancy; and
a reflector positioned about the diamond to reflect a portion of light emitted from the diamond, the reflector comprising a dielectric mirror film.

23. The DNV sensor of claim 22, wherein the dielectric mirror film reflects only red light.

24. The DNV sensor of claim 22, wherein the dielectric mirror film permits transmission of green light through the dielectric mirror film.

25. The DNV sensor of claim 22 further comprising:
a photo detector coupled to the reflector and configured to measure the reflected portion of light.

26. The DNV sensor of claim 25, wherein the photo detector is sealed to a portion of the reflector.

27. The DNV sensor of claim 25 further comprising:
an optical filter coupled to the photo detector.

28. The DNV sensor of claim 27, wherein the optical filter is a red filter.

29. The DNV sensor of claim 22, wherein the reflector is parabolic.

30. The DNV sensor of claim 22, wherein the reflector is ellipsoidal.

31. The DNV sensor of claim 22, wherein the reflector comprises a substrate, the dielectric mirror film being applied to the substrate.

32. The DNV sensor of claim 31, wherein the substrate possesses a high clarity at a frequency of interest for the DNV sensor.

33. The DNV sensor of claim 31, wherein the substrate is one of a plastic, glass, diamond, or quartz.

34. A diamond nitrogen-vacancy (DNV) sensor comprising:
a diamond having a nitrogen vacancy; and
a dielectric mirror film coated on the diamond.

35. The DNV sensor of claim 34, wherein the dielectric mirror film reflects only red light.

36. The DNV sensor of claim 34, wherein the dielectric mirror film permits transmission of green light through the dielectric mirror film.

37. The DNV sensor of claim 34 further comprising:
a photo detector coupled to the diamond and configured to measure a reflected portion of light.

38. The DNV sensor of claim 37, wherein the photo detector is sealed to a portion of the diamond.

39. The DNV sensor of claim 37 further comprising:
an optical filter coupled to the photo detector.

40. The DNV sensor of claim 39, wherein the optical filter is a red filter.

41. The DNV sensor of claim 34 further comprising:
a fiber conveying green light to the diamond.

42. The DNV sensor of claim 34 further comprising:
a microwave coil coiled about a portion of the diamond.

43. The DNV sensor of claim 34, wherein the diamond is parabolic in shape.

44. The DNV sensor of claim 34, wherein the diamond is ellipsoidal in shape.

45. A method for constructing a DNV sensor, the method comprising:
providing a diamond having a nitrogen vacancy; and
applying a dielectric mirror film coat to a portion of the diamond.

46. The method of claim 45 further comprising:
machining a portion of the diamond into a parabolic shape.

47. The method of claim 45 further comprising:
machining a portion of the diamond into an ellipsoidal shape.

48. The method of claim 45 further comprising:
positioning a photo detector relative to the diamond to receive light emitted from the diamond.

49. The method of claim 45, wherein a layer of the diamond does not have nitrogen vacancies.

50. A method for constructing a DNV sensor, the method comprising:
providing a diamond having a nitrogen vacancy;
machining a portion of the diamond to form a reflector; and
positioning a photo detector relative to the diamond to receive light emitted from the diamond.

51. The method of claim 50 further comprising:
applying a dielectric mirror film coat to a portion of the diamond.

52. The method of claim 50, wherein a layer of the diamond does not have nitrogen vacancies.

53. The method of claim 50, wherein a portion of the diamond is machined into a parabolic shape.

54. The method of claim 50, wherein a portion of the diamond is machined into an ellipsoidal shape.

55. A method for constructing a DNV sensor, the method comprising:
providing a diamond having a nitrogen vacancy and a reflector; and
positioning the diamond within the reflector such that the reflector reflects a portion of light from the diamond.

56. The method of claim 55 further comprising:
positioning a photo detector relative to the diamond to receive light reflected by the reflector.

57. The method of claim 55, wherein the reflector is monolithic.

58. The method of claim 57, wherein the diamond is positioned within a borehole of the monolithic reflector.

59. The method of claim 58, wherein the borehole is backfilled.

60. The method of claim 57, wherein the reflector comprises two or more pieces, wherein positioning the diamond within the reflector comprises inserting the diamond between the two or more pieces.

61. The method of claim 60, wherein the diamond is substantially flat.

62. The method of claim 60, wherein the two or more pieces of the reflector are parabolic in shape.

63. The method of claim 62, wherein the diamond is positioned parallel to an axis of symmetry of the reflector.

64. The method of claim 62, wherein the diamond is positioned perpendicular to an axis of symmetry of the reflector.

65. The method of claim 60, wherein the two or more pieces of the reflector are ellipsoidal in shape.

66. The method of claim 65, wherein the diamond is positioned along a major axis of the reflector.

67. The method of claim 65, wherein the diamond is positioned along a minor axis of the reflector.

68. The method of claim 57, wherein positioning the diamond within the reflector comprises casting the reflector about the diamond.

69. A diamond nitrogen-vacancy (DNV) sensor comprising:
a diamond having a nitrogen vacancy;
a reflector positioned about the diamond to reflect a portion of light emitted from the diamond; and
a waveguide positioned within the reflector to direct light to the diamond.

70. The DNV sensor of claim 69 further comprising:
a photo detector to measure the portion of light emitted from the diamond.

71. The DNV sensor of claim 70, wherein the photo detector is sealed to a portion of the reflector.

72. The DNV sensor of claim 70 further comprising:
an emitter to emit light to excite the nitrogen vacancy of the diamond, the emitter positioned at a first end of the waveguide, the diamond positioned at a second end of the waveguide.

73. The DNV sensor of claim 72, wherein the emitter is positioned within the photo detector.

74. The DNV sensor of claim 73, wherein the emitter is positioned at a center of the photo detector.

75. The DNV sensor of claim 72, wherein the photo detector and emitter are positioned on a substrate.

76. The DNV sensor of claim 75, wherein the photo detector and emitter positioned on the substrate form a single chip.

77. The DNV sensor of claim 72 further comprising:
an optical filter coupled to the photo detector.

78. The DNV sensor of claim 77, wherein the optical filter is a red filter.

79. The DNV sensor of claim 69, wherein the reflector is parabolic.

80. The DNV sensor of claim 79, wherein the waveguide is positioned parallel to an axis of symmetry of the reflector.

81. The DNV sensor of claim 69, wherein the reflector is ellipsoidal.

82. The DNV sensor of claim 81, wherein the waveguide is positioned parallel to a major axis of the reflector.
